(19) United States
(12) Patent Application Publication
(10) Pub. No.: US 2015/0079348 A1
(43) Pub. Date: Mar. 19, 2015

(54) ANTIREFLECTION FILM AND METHOD FOR PRODUCING THE SAME

(71) Applicant: KABUSHIKI KAISHA TOYOTA CHUO KENKYUSHO, Nagakute-shi (JP)

(72) Inventors: Norihiro MIZOSHITA, Nagakute-shi (JP); Masahiko ISHII, Nagakute-shi (JP); Hiromitsu TANAKA, Nagakute-shi (JP)

(21) Appl. No.: 14/472,938

(22) Filed: Aug. 29, 2014

(30) Foreign Application Priority Data
Sep. 3, 2013 (JP) 2013-182492

(51) Int. Cl. G02B 1/11; C03C 23/00; C03C 17/25

(52) U.S. Cl. CPC G02B 1/115; G02B 1/113; C03C 17/25; C03C 23/007; C03C 2217/73; C03C 2218/32; C03C 2218/11
USPC 428/148; 428/312.8; 428/312.6; 106/409; 427/165

(57) ABSTRACT

An antireflection film comprises:

mesoporous nanoparticles having a metal oxide framework and an average particle diameter of 30 to 200 nm; and

a mesoporous transparent material having a metal oxide framework and filling voids among the nanoparticles.

### BACKGROUND OF THE INVENTION

1. Field of the Invention

The present invention relates to an antireflection film and a method for producing the same, and more specifically relates to an antireflection film having a mesoporous structure and a method for producing the antireflection film.

2. Related Background Art Conventionally, in order to prevent light reflection on surfaces of optical components and the like, various types of antireflection films have been studied. For example, W. Shimizu et al., ACS Appl. Mater. Interfaces, 2010, Vol. 2, No. 11, pp. 3128-3133 (Non-Patent Literature 1) discloses a microporous silica thin film having a low refractive index and a high Young's modulus, the film being formed of tetramethyl orthosilicate by a sol-gel method using a hydroxyacetone catalyst. Moreover, Japanese Unexamined Patent Application Publication No. 2009-237551 (Patent Literature 1) discloses an antireflection film which is a mesoporous silica film formed by aggregating mesoporous silica nanoparticles. Further, Japanese Unexamined Patent Application Publication No. 2009-40967 (Patent Literature 2) discloses an antireflection substrate formed using a resin composition for forming a film having a low refractive index, the resin composition containing fine mesoporous silica particles and a matrix forming material. International Publication No. WO2012/022983 (Patent Literature 3) discloses an antireflection film containing a binder and porous silica nanoparticles. Furthermore, Japanese Unexamined Patent Application Publication No. 2005-243319 (Patent Literature 4) discloses an antireflection coating formed using a coating composition containing hollow fine particles and a matrix forming material for forming a porous matrix.

### SUMMARY OF THE INVENTION

However, the microporous silica thin film described in Non-Patent Literature 1 does not always have sufficient antireflection properties. Moreover, the antireflection film made from aggregates of fine mesoporous silica particles described in Patent Literature 1 has excellent antireflection properties but not sufficient mechanical properties such as abrasion resistance. Further, the antireflection substrate described in Patent Literature 2 and the antireflection film described in Patent Literature 3 have improved mechanical properties such as abrasion resistance in comparison with an antireflection film made from aggregates of fine mesoporous silica particles, but have a problem that the antireflection properties are lowered. In addition, the antireflection coating described in Patent Literature 4 has a problem that it is difficult to increase the porosity of the matrix portion.

The present invention has been made in view of the above-described problems of the conventional techniques. An object of the present invention is to provide: an antireflection film having both antireflection properties and abrasion resistance; and a method for producing the antireflection film.

The present inventors have earnestly studied in order to achieve the above object. As a result, the present inventors have found that filling voids among mesoporous nanoparticles with a mesoporous transparent material results in an antireflection film having both antireflection properties and abrasion resistance, and excellent in light transmittance (transparency). This finding has led to the completion of the present invention.

Specifically, an antireflection film of the present invention comprises:

mesoporous nanoparticles having a metal oxide framework and an average particle diameter of 30 to 200 nm; and

a mesoporous transparent material having a metal oxide framework and filling voids among the nanoparticles.

In such an antireflection film of the present invention, it is preferable that at least one of the mesoporous nanoparticles and the mesoporous transparent material have a silica framework, and it is particularly preferable that both have a silica framework.

Moreover, in the antireflection film of the present invention, a porosity attributable to mesopores which is determined from a nitrogen adsorption isotherm is preferably 20 to 65%, an average refractive index measured by spectroscopic ellipsometry is preferably 1.20 to 1.44, and a content of the mesoporous nanoparticles in terms of metal atom is preferably 20 to 80% by mass.

Further, the antireflection film of the present invention preferably has a concavity and convexity structure on a surface thereof with projections having an average pitch of 30 to 200 nm and an average height of 20 to 150 nm, and preferably has a surface subjected to a hydrophobizing treatment.

In addition, a multilayer antireflection film of the present invention comprises:

a transparent film having a metal oxide framework; and

the antireflection film of the present invention arranged on a surface of the transparent film. The transparent film preferably has a silica framework.

A method for producing an antireflection film of the present invention comprises:

preparing a sol dispersion liquid containing mesoporous nanoparticles having .a metal oxide framework, a hydrophobized surface and an average particle diameter of 30 to 200 nm, a metal alkoxide, and a surfactant;

forming a coating film using the sol dispersion liquid; and

calcining the obtained coating film to form a film containing the mesoporous nanoparticles and a mesoporous transparent material. Such a method for producing an antireflection film of the present invention preferably comprises subjecting a surface of the film obtained after the calcination to a hydrophobizing treatment.

Moreover, a method for producing a multilayer antireflection film of the present invention comprises forming a film containing the mesoporous nanoparticles and the mesoporous transparent material on a surface of a transparent film having a metal oxide framework by the method for producing an antireflection film of the present invention.

Note that although it is not exactly clear why the antireflection film of the present invention has both antireflection properties and abrasion resistance, the present inventors speculate as follows. Specifically, in order to obtain a film having excellent antireflection properties, it is effective to use a material having a low refractive index as the film material. Nevertheless, in order to obtain an antireflection film having a useful refractive index (i.e., a refractive index between those of air (approximately 1) and a glass (approximately 1.5)), the use of only a film material having a low refractive index is insufficient, and it is necessary to further introduce into the film pores or voids having a diameter equal to or smaller than a wavelength of visible light. However, since the optical properties and mechanical properties of a film are in a relationship of a trade-off, there is a problem that increasing the porosity of a film to improve the optical properties decreases the mechanical properties of the film. For this reason, the antireflection film made from aggregates of fine mesoporous silica particles described in Patent Literature 1 exhibits excellent antireflection properties due to a high porosity, but has a problem of low abrasion resistance due to large voids among the nanoparticles.

Moreover, the antireflection properties can also be improved by forming a fine concavity and convexity structure on the film surface. Particularly, the antireflection properties can be greatly improved by increasing the heights of projections in the concavity and convexity structure. Nevertheless, if projections are too tall, this brings about a problem that the film has low abrasion resistance.

Further, in a case where mesoporous silica nanoparticles are partially immobilized with a silica binder or the like, when a stress is applied to the film, the stress is concentrated on the weakest portions in the structure, that is, contact points between the nanoparticles and contact points between the nanoparticles and the substrate, bringing about a problem that the film is destroyed.

On the other hand, in the antireflection film of the present invention, voids among mesoporous nanoparticles 1 are filled with a mesoporous transparent material 2 as shown in FIG. 1, and the nanoparticles 1 are firmly fixed to each other. Accordingly, it is speculated that a stress is hardly concentrated, a sufficient and uniform mechanical strength is ensured in the entire antireflection film, and the abrasion resistance is improved in comparison with an antireflection film made from aggregates of mesoporous nanoparticles and an antireflection film obtained by partially immobilizing mesoporous silica nanoparticles with a silica binder or the like. Moreover, in the antireflection film of the present invention, besides a region of the nanoparticles 1, mesopores 2 a are formed in a region filled with the transparent material 2 (matrix portion), so that mesopores la and the mesopores 2a are present across the entire film. Accordingly, it is speculated that the antireflection properties are increased due to the high porosity in comparison with a porous film whose matrix portion is made of a non-porous material.

Further, a concavity and convexity structure is formed on the surface of the antireflection film of the present invention, the structure having mesoporous nanoparticles exposed as appropriate and projections with appropriate heights. Accordingly, it is speculated that the antireflection properties are improved without impairing the abrasion resistance.

According to the present invention, an antireflection film having both antireflection properties and abrasion resistance and excellent in light transmittance can be easily obtained.

### BRIEF DESCRIPTION OF THE DRAWINGS

FIG. 1 is a cross-sectional view schematically showing a substrate on which an antireflection film of the present invention is arranged.

FIG. 2 is a graph showing a nitrogen adsorption isotherm of a mesoporous silica-mixed thin film obtained in Example 1.

FIG. 3 is a graph showing a pore diameter distribution of the mesoporous silica-mixed thin film obtained in Example 1.

FIG. 4 is a graph showing of a pore diameter distribution of a thin film consisting of mesoporous silica nanoparticles obtained in Preparation Example 1.

FIG. 5 is a graph showing the ²⁹Si solid-state MAS-NMR measurement result of the mesoporous silica-mixed thin film obtained in Example 1.

FIG. 6 is a schematic view for illustrating a structural change during a calcination process when a mesoporous silica-mixed thin film is produced.

FIG. 7 is a scanning electron micrograph of the mesoporous silica-mixed thin film obtained in Example 1.

FIG. 8 is a transmission electron microphotograph of the mesoporous silica-mixed thin film obtained in Example 1.

FIG. 9 is a graph showing a wavelength dependence of a light transmittance of a glass substrate on surfaces of which the mesoporous silica-mixed thin films were arranged, which was obtained in Example 1.

FIG. 10 is a graph showing a wavelength dependence of a light reflectance of the glass substrate on the surfaces of which the mesoporous silica-mixed thin films were arranged, which was obtained in Example 1.

FIG. 11 is a graph showing a wavelength dependence of a light transmittance of a glass substrate on surfaces of which mesoporous silica-mixed thin films were arranged, which was obtained in Example 2.

FIG. 12 is a graph showing a wavelength dependence of a light reflectance of the glass substrate on the surfaces of which the mesoporous silica-mixed thin films were arranged, which was obtained in Example 2.

FIG. 13 is a graph showing a nitrogen adsorption isotherm of a silica-mixed thin film obtained in Comparative Example 7.

### DETAILED DESCRIPTION OF THE PREFERRED EMBODIMENTS

Hereinafter, the present invention will be described in details on the basis of preferred embodiments thereof.

First of all, an antireflection film of the present invention will be described. The antireflection film of the present invention comprises: mesoporous nanoparticles having a metal oxide framework and an average particle diameter of 30 to 200 nm; and a mesoporous transparent material having a metal oxide framework and filling voids among the nanoparticles.

The nanoparticles and the transparent material according to the present invention are mesoporous nanoparticles and mesoporous transparent material having a large number of mesopores of 2 to 50 nm in diameter. Providing a structure having a large number of mesopores (mesoporous structure) makes it possible to decrease the refractive index while sufficiently ensuring the porosities of the nanoparticles and the transparent material, so that the film materials become excellent in antireflection properties. Moreover, since the voids among the nanoparticles are sufficiently filled with the mesoporous material, the mechanical strength of the antireflection film is sufficiently ensured; in addition, light is hardly scattered, and the transparency of the antireflection film is also ensured.

On the other hand, if a microporous material having a large number of micropores of less than 2 nm in diameter is used instead of the mesoporous transparent material, the voids among the mesoporous nanoparticles as well as mesopores in the mesoporous nanoparticles are filled with the microporous material. Hence, the amount of the microporous material filling the voids among the nanoparticles is decreased, which decreases the mechanical strength of the film and decreases the porosity of the mesoporous nanoparticles, thereby increasing the refractive index, so that the antireflection properties of the film are lowered.

Moreover, if a macroporous material having a large number of macropores of more than 50 nm in diameter is used instead of the mesoporous transparent material, light is scattered by the macropores. Hence, the transparency of the film is decreased. Further, if the diameter of the macropores is almost the same as or larger than the average thickness of the film, or if the macropores is larger than the voids among the mesoporous nanoparticles, there would be voids not filled with the macroporous material among the mesoporous nanoparticles; hence, the uniformity and the mechanical strength of the film are lowered.

Meanwhile, the metal oxide framework constituting such mesoporous nanoparticles and mesoporous transparent material is not particularly limited, as long as the framework is formed of a metal oxide having a light absorption coefficient of 2000 cm⁻¹ or less in the visible light region (400 to 800 nm). Nevertheless, from the viewpoint that excellent antireflection properties are obtained, the framework is preferably formed of a metal oxide having a refractive index of 3.0 or less. Examples of such a metal oxide include silica (light absorption coefficient: less than 0.1 cm⁻¹, refractive index: 1.45), alumina (light absorption coefficient: less than 0.1 cm⁻¹, refractive index: 1.76), titania (light absorption coefficient: less than 1000 cm⁻¹, refractive index: 2.52), and the like. Moreover, metal oxides described in P. Yang et al. (Chem. Mater. 1999, Vol. 11, pp. 2813-2826) and F. Schuth et al. (Chem. Mater. 2001, Vol. 13, pp. 3184-3195) can also be used. Among these metal oxide frameworks, a silica framework is particularly preferable from the viewpoints that the refractive index is low and excellent antireflection properties are obtained. Further, in the present invention, the metal oxide framework constituting the mesoporous nanoparticles may be the same as or different from the metal oxide framework constituting the mesoporous transparent material. Nevertheless, the metal oxide frameworks are preferably the same from the viewpoints that light is hardly reflected at an interface between the mesoporous nanoparticles and the mesoporous transparent material and excellent antireflection properties are obtained. Furthermore, an organic group may be bonded to such metal oxide frameworks.

In the present invention, the mesoporous nanoparticles have an average particle diameter of 30 to 200 nm. If the average particle diameter of the mesoporous nanoparticles is less than the lower limit, a concavity and convexity structure is hardly formed on a surface of the antireflection film, and sufficient antireflection properties cannot be obtained. On the other hand, if the average particle diameter exceeds the upper limit, an interaction with visible light causes light scattering or light interference, decreasing the transparency of the film. From the viewpoints of further improving the antireflection properties and the transparency, the average particle diameter of the mesoporous nanoparticles is preferably 50 to 150 nm, more preferably 70 to 130 nm. Herein, the average particle diameter of the mesoporous nanoparticles can be measured by dynamic light scattering.

The antireflection film of the present invention comprises the mesoporous nanoparticles and the mesoporous transparent material, and has a structure in which voids among the mesoporous nanoparticles are filled with the mesoporous transparent material. In such an antireflection film, a content of the mesoporous nanoparticles in terms of metal atom is preferably 20 to 80% by mass, more preferably 30 to 70% by mass, and particularly preferably 35 to 65% by mass. Additionally, a content of the mesoporous transparent material in terms of metal atom is preferably 80 to 20% by mass, more preferably 70 to 30% by mass, and particularly preferably 65 to 35% by mass. If the content of the mesoporous nanoparticles is less than the lower limit, there are tendencies that the concavity and convexity structure is hardly formed on the surface of the antireflection film, and sufficient antireflection properties cannot be obtained. On the other hand, if the content exceeds the upper limit, the nanoparticles tend to be weakly immobilized (bind) to each other with a transparent resin, and the abrasion resistance tends to be lowered. Herein, the contents of the mesoporous nanoparticles and the mesoporous transparent material in terms of metal atom are respectively calculated according to the following formulas:

The content (% by mass) of the mesoporous nanoparticles=the amount of metal atoms in the mesoporous nanoparticles/(the amount of metal atoms in the mesoporous nanoparticles+the amount of metal atoms in the mesoporous transparent material)×100.

The content (% by mass) of the mesoporous transparent material =the amount of metal atoms in the mesoporous transparent material/(the amount of metal atoms in the mesoporous nanoparticles+the amount of metal atoms in the mesoporous transparent material)×100.

Additionally, the antireflection film of the present invention has a concavity and convexity structure on a surface thereof. Projections of the concavity and convexity structure have an average pitch of preferably 30 to 200 nm, more preferably 50 to 150 nm, and an average height of preferably 20 to 150 nm, more preferably 25 to 100 nm, and particularly preferably 30 to 75 nm. Herein, a height of a projection in the concavity and convexity structure means a height from a bottom portion of a concavity to a top portion of a convexity. If the average pitch or the average height of the projections is less than the lower limit, there are tendencies that a change of the refractive index in a film thickness direction is small, and the antireflection properties are lowered. On the other hand, if the average pitch or the average height exceeds the upper limit, there are tendencies that the abrasion resistance of the film is lowered, and an interaction with visible light causes light scattering or light interference, decreasing the transparency of the film. Herein, the average pitch and the average height of projections in a concavity and convexity structure are determined as follows. Specifically, a region of 10 μm square is randomly extracted from a SEM photograph obtained by scanning electron microscope (SEM) observation, and 20 or more projections are randomly extracted from this region. Heights of the projections and distances between the centers of the adjacent two projections are measured and averaged to thus determine the average pitch and the average height, respectively.

Further, in the antireflection film of the present invention, a porosity attributable to mesopores is preferably 20 to 65%, more preferably 25 to 55%. If the porosity is less than the lower limit, the refractive index tends to be not sufficiently decreased, and the antireflection properties tend to be lowered. On the other hand, if the porosity exceeds the upper limit, there are tendencies that sufficient mechanical strength cannot be obtained, and the abrasion resistance is lowered. Herein, the porosity is a weighted average of a porosity attributable to mesopores in the mesoporous nanoparticles and a porosity attributable to mesopores in the mesoporous transparent material, and is determined based on the true density of the mesoporous nanoparticles, the true density of the mesoporous transparent material, and a nitrogen adsorption isotherm.

Moreover, in the antireflection film of the present invention, an average refractive index of the entire film is preferably 1.20 to 1.44. It tends to be difficult to produce an antireflection film having an average refractive index less than the lower limit; in addition, the difference in the refractive index from the substrate material (glass or the like) is large, and hence, the antireflection properties tend to be lowered. On the other hand, if the average refractive index exceeds the upper limit, the antireflection properties tend to be lowered. Herein, the average refractive index can be measured by spectroscopic ellipsometry.

Furthermore, the antireflection film of the present invention has an average film thickness of preferably 50 to 250 nm, more preferably 80 to 150 nm. If the average film thickness is less than the lower limit, a phase variation of light that passes through the film tends to become small, and the antireflection properties tend to be lowered. On the other hand, if the average film thickness exceeds the upper limit, there are tendencies that an interaction with visible light causes light interference, and the transparency of the film is lowered. Herein, the average film thickness can be measured by spectroscopic ellipsometry.

Moreover, in a multilayer antireflection film of the present invention, such an antireflection film of the present invention is arranged on a surface of a transparent film having a metal oxide framework. When the antireflection film of the present invention is arranged on the surface of the transparent film, the light transmittance and the antireflection properties tend to be improved in comparison with a case of the antireflection film alone. Examples of the metal oxide framework constituting the transparent film include the metal oxide frameworks exemplified as the metal oxide frameworks constituting the mesoporous nanoparticles and the mesoporous transparent material. Moreover, the metal oxide framework constituting the transparent film is preferably the same metal oxide framework as the metal oxide framework constituting the mesoporous nanoparticles and the mesoporous transparent material from the viewpoints that light is hardly reflected at an interface between the antireflection film of the present invention and the transparent film, and excellent antireflection properties are obtained.

Further, the transparent film has an average film thickness of preferably 50 to 250 nm, more preferably 80 to 150 nm. If the average film thickness of the transparent film is less than the lower limit, a phase variation of light that passes through the film tends to become small, making it difficult to reduce the light reflectance, and the antireflection properties tend to be lowered. On the other hand, if the average film thickness exceeds the upper limit, there are tendencies that a color is developed due to a light interference effect, and the transparency of the film is lowered. Herein, the average film thickness can be measured by spectroscopic ellipsometry.

Next, a method for producing an antireflection film of the present invention will be described. The method for producing an antireflection film of the present invention comprises:

preparing a sol dispersion liquid containing mesoporous nanoparticles having a metal oxide framework, a hydrophobized surface and an average particle diameter of 30 to 200 nm, a metal alkoxide, and a surfactant;

forming a coating film using the sol dispersion liquid; and

calcining the obtained coating film to form a film containing the mesoporous nanoparticles and a mesoporous transparent material.

In the method for producing an antireflection film of the present invention, the mesoporous nanoparticles used have a metal oxide framework and an average particle diameter of 30 to 200 nm, and have a surface subjected to a hydrophobizing treatment (i.e., a hydrophobic group is introduced to the surface) (hereinafter may also be referred to as “surface-hydrophobized mesoporous nanoparticles”). The surface-hydrophobized mesoporous nanoparticles do not react with the metal alkoxide when a coating film is formed. However, the hydrophobic group introduced to the surface of the surface-hydrophobized mesoporous nanoparticles is decomposed by the calcination to be described later, and a metal atom on the nanoparticle surface is bonded via an oxygen atom to a metal atom of the mesoporous transparent material formed from the metal alkoxide, so that an antireflection film excellent in mechanical strength is obtained. Moreover, the surface-hydrophobized mesoporous nanoparticles hardly aggregate in a solvent, making it possible to stably store the sol dispersion liquid for a long period.

The surface-hydrophobized mesoporous nanoparticles used in the method for producing an antireflection film of the present invention have a structure having a large number of mesopores of 2 to 50 nm in diameter (mesoporous structure). This makes it possible to obtain an antireflection film excellent in antireflection properties. Moreover, examples of the metal oxide framework constituting such surface-hydrophobized mesoporous nanoparticles include the metal oxide frameworks exemplified as the metal oxide framework constituting the mesoporous nanoparticles. Among these, a silica framework is particularly preferable from the viewpoint that an antireflection film excellent in antireflection properties is obtained. Further, the surface-hydrophobized mesoporous nanoparticles have an average particle diameter of 30 to 200 nm, preferably 50 to 150 nm, and more preferably 70 to 130 nm. The use of the surface-hydrophobized mesoporous nanoparticles having such an average particle diameter makes it possible to obtain an antireflection film excellent in antireflection properties and transparency.

Such surface-hydrophobized mesoporous nanoparticles can be produced by a known method. For example, when a metal alkoxide is hydrolyzed and condensed in the presence of a surfactant to prepare mesoporous nanoparticles, an acid and an organometallic compound having a hydrocarbon group (hydrophobic group) such as an alkyl group are added, or a halogenated organometallic compound having a hydrocarbon group (hydrophobic group) such as an alkyl group is added, to thereby introduce the hydrocarbon group to the surface of the mesoporous nanoparticles, so that the surface-hydrophobized mesoporous nanoparticles can be obtained. Meanwhile, after a metal alkoxide is hydrolyzed and condensed in the presence of a surfactant to prepare mesoporous nanoparticles, the mesoporous nanoparticles are subjected to a surface treatment using a fluorinated coupling agent, so that the surface of the mesoporous nanoparticles can be hydrophobized.

The metal alkoxide includes metal tetraalkoxides having four alkoxy groups, metal trialkoxides having three alkoxy groups, and metal dialkoxides having two alkoxy groups. From the viewpoint that mesoporous nanoparticles excellent in mechanical strength are obtained, metal tetraalkoxides and metal trialkoxides are preferable, and metal tetraalkoxides are more preferable. A metal atom constituting such a metal alkoxide includes metal atoms constituting the metal oxide framework such as a silicon atom, an aluminium atom, and a titanium atom, and a silicon atom is particularly preferable. Moreover, the alkoxy group includes a methoxy group, an ethoxy group, a propoxy group, and a butoxy group.

Specific examples of such metal alkoxides include tetraalkoxysilanes such as tetramethoxysilane, tetraethoxysilane, tetraisopropoxysilane, tetrabutoxysilane, and dimethoxydiethoxysilane; trialkoxysilanes such as trimethoxysilanol, triethoxysilanol, trimethoxymethylsilane, trimethoxyvinylsilane, triethoxyvinylsilane, 3-glycidoxypropyltriethoxysilane, 3-mercaptopropyltrimethoxysilane, 3-chloropropyltrimethoxysilane, 3-(2-aminoethyl)aminopropyltrimethoxysilane, phenyltrimethoxysilane, phenyltriethoxysilane, γ-(methacryloxypropyl)trimethoxysilane, and β-(3,4-epoxycyclohexyl)ethyltrimethoxysilane; dialkoxysilanes such as dimethoxydimethylsilane, diethoxydimethylsilane, diethoxy-3-glycidoxypropylmethylsilane, dimethoxydiphenylsilane, and dimethoxymethylphenylsilane; titanium tetraalkoxides such as titanium tetraethoxide, titanium tetraisopropoxide, and titanium tetrabutoxide; aluminium trialkoxides such as aluminium triethoxide, aluminium triisopropoxide, and aluminium tributoxide; and the like. Among these, tetraalkoxysilanes, trialkoxysilanes, and dialkoxysilanes are preferable, and tetraalkoxysilanes and trialkoxysilanes are more preferable. Moreover, one kind of these metal alkoxides may be used alone, or two or more kinds thereof may be used in combination.

The surfactant includes alkylammonium halides having a long chain alkyl group with 8 to 26 carbon atoms. Among these, preferable are alkyltrimethylammonium halides having a long chain alkyl group with 9 to 26 carbon atoms such as tetradecyltrimethylammonium halides, hexadecyltrimethylammonium halides, and octadecyltrimethylammonium halides. More preferable are tetradecyltrimethylammonium halides and hexadecyltrimethylammonium halides. Particularly preferable are tetradecyltrimethylammonium chloride and hexadecyltrimethylammonium chloride.

Additionally, the organometallic compound includes organosilicon compounds such as hexaalkyldisiloxanes (for example, hexamethyldisiloxane, hexaethyldisiloxane), hexaalkyldisilazanes (for example, hexamethyldisilazane), trialkylmonoalkoxysilanes (for example, trimethylmethoxysilane and trimethylethoxysilane); organotitanium compounds such as tetrakis(trimethylsiloxy)titanium; and organoaluminium compounds such as aluminium alkyl acetoacetate diisopropoxides. Among these, it is preferable to use an organometallic compound containing the same metal atom as that in the metal alkoxide used. Furthermore, the acid includes hydrochloric acid, acetic acid, nitric acid, trifluoroacetic acid, paratoluenesulfonic acid, sulfuric acid, and the like.

Moreover, the halogenated organometallic compound includes halogenated organosilicon compounds such as chlorotrialkylsilanes (for example, chlorotrimethylsilane, chlorotriethylsilane) and fluorotrialkylsilanes (for example, fluorotrimethylsilane, fluorotriethylsilane).

Further, the fluorinated coupling agent includes fluorine-containing silane coupling agents such as (3,3,3-trifluoropropyl)dimethylchlorosilane and (heptadecafluoro-1,1,2,2-tetrahydrodecyl)dimethylchlorosila ne.

Meanwhile, the metal alkoxide used to form the mesoporous transparent material in the method for producing an antireflection film of the present invention includes the metal alkoxides exemplified for the surface-hydrophobized mesoporous nanoparticles. Among these, preferable are metal tetraalkoxides (for example, tetraalkoxysilanes, titanium tetraalkoxides, aluminium trialkoxides) and metal trialkoxides (for example, trialkoxysilanes), and more preferable are metal tetraalkoxides, from the viewpoints that the mechanical strength of the mesoporous transparent material is improved and an antireflection film having excellent mechanical properties is obtained. Moreover, a metal atom constituting such a metal alkoxide may be the same as or different from a metal atom constituting the surface-hydrophobized mesoporous nanoparticles. Nevertheless, from the viewpoint that an antireflection film excellent in antireflection properties is obtained, the same metal atom is preferable.

Further, the surfactant used in the method for producing an antireflection film of the present invention may be anyone of cationic, anionic, and non-ionic surfactants. Specifically, the surfactant includes chlorides, bromides, iodides, and hydroxides of alkyltrimethylammonium, alkyltriethylammonium, dialkyldimethylammonium, benzyl ammonium, and the like; fatty acid salts, alkylsulfonates, alkylphosphates, polyethylene oxide-based non-ionic surfactants, primary alkylamines, and the like. One kind of these surfactants may be used alone, or two or more kinds thereof may be used in combination. The use of such a surfactant makes it difficult to fill the mesopores of the surface-hydrophobized mesoporous nanoparticles with the mesoporous transparent material because a micelle structure formed by the surfactant is difficult to penetrate into the mesopores of the surface-hydrophobized mesoporous nanoparticles.

Among the above surfactants, polyethylene oxide-based non-ionic surfactants are preferable from the viewpoint of making it difficult to fill the mesopores of the surface-hydrophobized mesoporous nanoparticles with the mesoporous transparent material. Examples of such polyethylene oxide-based non-ionic surfactants include polyethylene oxide-based nonionic surfactants each having a hydrocarbon group as a hydrophobic component and polyethylene oxide as a hydrophilic component, and the like. Moreover, as such a surfactant, more preferably used is one represented by a general formula, for example, CₙH₂ₙ₊₁(OCH₂CH₂)ₘOH, where n is 10 to 30 and m is 1 to 30. Further, esters of sorbitan and a fatty acid such as oleic acid, lauric acid, stearic acid, and palmitic acid, or compounds formed by adding polyethylene oxide to these esters can also be used as the polyethylene oxide-based non-ionic surfactant.

Further, a triblock copolymer of polyalkylene oxide can also be used as the polyethylene oxide-based non-ionic surfactant. Examples of such a surfactant include ones made of polyethylene oxide (EO) and polypropylene oxide (PO), and represented by a general formula (EO)ₓ(PO)_{y}(EO)ₓ. Here, x and y represent the numbers of repetitions of EO and PO, respectively. It is preferable that x be 5 to 110 and y be 15 to 70, and more preferable that x be 13 to 106 and y be 29 to 70. The triblock copolymer includes (EO)₁₉(PO)₂₉(EO)₁₉, (EO)₁₃(PO)₇₀(EO)₁₃(EO)₅(PO)₇₀(EO)₅, (EO)₁₃(PO)₃₀(EO)₁₃, (EO)₂₀(PO)₃₀(EO)₂₀, (EO)₂₆(PO)₃₉(EO)₂₆, (EO)₁₇(PO)₅₆(EO)₁₇, (EO)₁₇(PO)₅₈(EO)₁₇, (EO)₂₀(PO)₇₀(EO)₂₀, (EO)₈₀(PO)₃₀(EO)₈₀, (EO)₁₀₆(PO)₇₀(EO)₁₀₆, (EO)₁₀₀(PO)₃₉(EO)₁₀₀(EO)₁₉(PO)₃₃(EO)₁₉, and (EO)₂₆(PO)₃₆(EO)₂₆. These triblock copolymers are available from BASF Group, Sigma-Aldrich Corp., and so forth. In addition, triblock copolymers having desired x and y values can be obtained in a small-scale production level.

Furthermore, a star diblock copolymer formed by binding two chains of a polyethylene oxide (EO) chain-polypropylene oxide (PO) chain to each of two nitrogen atoms of ethylenediamine can also be used as the polyethylene oxide-based non-ionic surfactant. Such a star diblock copolymer includes one represented by a general formula ((EO)ₓ(PO)_{y})₂NCH₂CH2N((PO)_{y}(EO)ₓ)₂. Here, x and y represent the numbers of repetitions of EO and PO, respectively. It is preferable that x be 5 to 110 and y be 15 to 70, and more preferable that x be 13 to 106 and y be 29 to 70.

Alternatively, among the surfactants, a salt (preferably a halide salt) of alkyltrimethylammonium [CₚH₂ₚ₊₁N (CH₃)₃] is preferably used, and the alkyltrimethylammonium more preferably has an alkyl group with 8 to 22 carbon atoms, from the viewpoint that a mesoporous transparent material having highly ordered mesopores is obtained. Examples of such a surfactant include octadecyltrimethylammonium chloride, hexadecyltrimethylammonium chloride, tetradecyltrimethylammonium chloride, dodecyltrimethylammonium bromide, decyltrimethylammonium bromide, octyltrimethylammonium bromide, docosyltrimethylammonium chloride, and the like.

Meanwhile, in the method for producing an antireflection film of the present invention, instead of or in combination with the surfactant, fine resin particles can be used which are removable by calcination or washing with a solvent from a transparent material obtained by hydrolyzing and condensing the metal alkoxide. Examples of such fine resin particles include polystyrene nanoparticles, latex nanoparticles, and the like.

In the method for producing an antireflection film of the present invention, first, the surface-hydrophobized mesoporous nanoparticles, the metal alkoxide, the surfactant, and a solvent are mixed to prepare a sol solution. The solvent includes alcohols such as methanol, ethanol, n-propanol, and isopropanol; and water-soluble organic solvents such as acetone, tetrahydrofuran, and N,N-dimethylformamide.

A concentration of the surface-hydrophobized mesoporous nanoparticles in the sol solution is preferably 0.1 to 10% by mass from the viewpoint of obtaining a sol solution in which the nanoparticles are uniformly dispersed. Moreover, in the sol solution, a proportion of the surface-hydrophobized mesoporous nanoparticles in terms of metal atom is preferably 20 to 80% by mass, more preferably 30 to 70% by mass, and particularly preferably 35 to 65% by mass; a proportion of the metal alkoxide in terms of metal atom is preferably 80 to 20% by mass, more preferably 70 to 30% by mass, and particularly preferably 65 to 35% by mass, relative to a total amount of the surface-hydrophobized mesoporous nanoparticles and the metal alkoxide. If the proportion of the surface-hydrophobized mesoporous nanoparticles is less than the lower limit, there is a tendency that a desired concavity and convexity structure is hardly formed on a surface of a film to be obtained. On the other hand, if the proportion exceeds the upper limit, the voids among the mesoporous nanoparticles tend to be not sufficiently filled with the mesoporous transparent material, and there are tendencies that a film having a desired porosity is not obtained, and the abrasion resistance is lowered. Herein, the proportions of the surf ace-hydrophobized mesoporous nanoparticles and the metal alkoxide in the sol solution are respectively calculated according to the following formulas:

The proportion (% by mass) of the surface-hydrophobized mesoporous nanoparticles=the amount of metal atoms in the surface-hydrophobized mesoporous nanoparticles/(the amount of metal atoms in the surf ace-hydrophobized mesoporous nanoparticles+the amount of metal atoms in the metal alkoxide)×100.

The proportion (% by mass) of the metal alkoxide=the amount of metal atoms in the metal alkoxide/(the amount of metal atoms in the surface-hydrophobized mesoporous nanoparticles+the amount of metal atoms in the metal alkoxide)×100.

Moreover, a content of the surfactant in the sol solution is preferably 5 to 50 parts by mass relative to 100 parts by mass of the metal alkoxide. If the content of the surfactant is less than the lower limit, there are tendencies that mesopores are not sufficiently formed in the transparent material (matrix portion) formed by hydrolyzing and condensing the metal alkoxide, and the mesopores of the surf ace-hydrophobized mesoporous nanoparticles are filled with the transparent material. On the other hand, if the content exceeds the upper limit, there are tendencies that a larger amount of the surfactant remains unreacted in the sol solution, and a uniform mesoporous structure is hardly formed.

Next, the sol solution prepared as described above is applied to a surface of a transparent substrate such as a glass substrate to a desired thickness. The method for applying the sol solution is not particularly limited. It is possible to adopt a known method such as gravure coating, spin coating, dip coating, spray coating, or brush coating.

Then, the obtained coating film is dried, followed by calcination. This hydrolyzes and condenses the metal alkoxide, forming a film in which the voids among the mesoporous nanoparticles are filled with the transparent material. In this event, the surfactant is removed by the calcination, and a mesoporous structure is formed in the transparent material (matrix portion), so that a film having a low refractive index and excellent in antireflection properties is obtained. Moreover, the hydrophobic group introduced to the surface of the surface-hydrophobized mesoporous nanoparticles is decomposed by the calcination, and a metal atom on the nanoparticle surface is bonded via an oxygen atom to a metal atom of the mesoporous transparent material formed from the metal alkoxide, so that an antireflection film excellent in mechanical strength is obtained.

The calcination conditions are not particularly limited, as long as the hydrolysis and condensation of the metal alkoxide sufficiently proceed, the surfactant is sufficiently removed, and the mesoporous nanoparticles and the mesoporous transparent material firmly bind to each other. For example, the calcination temperature is preferably 200 to 800° C., and the calcination time is preferably 0.5 to 12 hours.

Moreover, the method for producing an antireflection film of the present invention preferably comprises subjecting a surface of the film obtained after the calcination to a hydrophobizing treatment. Thereby, the light (particularly, light having a short wavelength) transmittance and the antireflection properties tend to be improved. The hydrophobizing treatment can be performed by bringing a coupling agent into contact with the film after the calcination. For example, while the film after the calcination is being immersed in a solution containing a coupling agent, heating the film introduces a hydrophobic group (for example, a hydrocarbon group such as an alkyl group) derived from the coupling agent to the surface of the film.

The coupling agent is not particularly limited, as long as it is capable of introducing the hydrophobic group. Examples of the coupling agent include silane coupling agents such as trialkylchlorosilanes (for example, trimethylchlorosilane, triethylchlorosilane, tripropylchlorosilane), trifluoroalkyldialkylsilanes (for example, trifluoropropyldimethylchlorosilane), and (heptadecafluoro-1,1,2,2-tetrahydrodecyl)dimethylchlorosilane.

A method for producing a multilayer antireflection film of the present invention comprises forming a film containing the mesoporous nanoparticles and the mesoporous transparent material on a surface of a transparent film having a metal oxide framework by the method for producing an antireflection film of the present invention. This makes it possible to obtain a multilayer antireflection film having improved light transmittance and antireflection properties in comparison with an antireflection film obtained by the method for producing an antireflection film of the present invention. The transparent film used in such a method for producing a multilayer antireflection film can be prepared, for example, by the following method. Specifically, first, a sol solution containing an organometallic compound is prepared. The organometallic compound includes organosilicon compounds such as polysiloxanes (for example, polydimethoxysiloxane, polydiethoxysiloxane) , tetraalkoxysilanes (for example, tetramethoxysilane, tetraethoxysilane, tetrapropoxysilane); organotitanium compounds such as titanium alkoxides (for example, titanium methoxide, titanium ethoxide, titanium propoxide, titanium butoxide); and organoaluminium compounds such as aluminium alkoxides (for example, aluminium(III) ethoxide, aluminium(III) propoxide, aluminium (III) butoxide). Among these, from the viewpoints of further improving the light transmittance and the antireflection properties of the multilayer antireflection film, preferable are organometallic compounds containing the same metal atom as the metal atom constituting the antireflection film.

Next, the sol solution prepared as described above is applied to a surface of a transparent substrate such as a glass substrate to a desired thickness. The method for applying the sol solution is not particularly limited. It is possible to adopt a known method such as gravure coating, spin coating, dip coating, spray coating, or brush coating.

Then, the obtained coating film is dried, followed by calcination to thereby obtain a transparent film having a metal oxide framework. The calcination conditions are not particularly limited. For example, the calcination temperature is preferably 300 to 800° C., and the calcination time is preferably 0.5 to 12 hours.

By the method for producing a multilayer antireflection film of the present invention, the film containing the mesoporous nanoparticles and the mesoporous transparent material is formed on the surface of the transparent film prepared as described above according to the method for producing an antireflection film of the present invention. The multilayer antireflection film produced in this manner tends to have improved light transmittance and antireflection properties in comparison with a case of the antireflection film of the present invention alone.

### Examples

Hereinafter, the present invention will be more specifically described on the basis of Examples and Comparative Examples. However, the present invention is not limited to the following Examples. Note that the structural analysis of thin films, and evaluations of optical properties and mechanical properties thereof were performed according to the following methods.

### <Nitrogen Adsorption Isotherm, Pore Diameter Distribution, and Porosity>

A nitrogen adsorption isotherm was measured using a gas sorption analyzer “Autosorb-1” manufactured by Quantachrome Instruments. Moreover, a pore diameter distribution was determined from the obtained nitrogen adsorption isotherm by a density functional method. Further, a porosity attributable to mesopores was calculated using a maximum amount of nitrogen adsorbed determined from the nitrogen adsorption isotherm, provided that the density of silica is 2.2 g/cm³.

### <NMR Measurement>

A ²⁹Si solid-state MAS (Magic Angle Spinning)-NMR measurement was performed using a nuclear magnetic resonance spectrometer “AVANCE400” manufactured by Bruker Corporation.

### <Electron Microscope Observation>

A scanning electron microscope observation was made using a scanning electron microscope “S-4300” manufactured by Hitachi High-Technologies Corporation. Meanwhile, a transmission electron microscope observation was made using a nano-probe electron spectroscopy type electron microscope “JEM-2010FEF” manufactured by JEOL Ltd.

### <Average Pitch and Average Height of Projections>

An average pitch and an average height of projections were determined by randomly extracting a region of 10 μm square from a SEM photograph obtained by the scanning electron microscope (SEM) observation, randomly extracting 20 or more projections from this region, and measuring and averaging heights of the projections and distances between the centers of the adjacent two projections.

### <Film Thickness and Refractive Index>

A film thickness and a refractive index were measured using a spectroscopic ellipsometer “M-2000U” manufactured by J. A. Woollam Co.

### <Light Transmittance>

A light transmittance was measured using a spectrophotometer “V-690” manufactured by JASCO Corporation.

### <Light Reflectance>

A light reflectance was measured using a multi-channel spectrometer “S-2656” manufactured by Soma Optics, Ltd.

### <Abrasion Resistance Test>

While being pressed at a pressure of 5 kg/cm² against a surface of a thin film, a cotton wool was moved back and forth 20 times. Then, the state of the surface of the thin film was visually observed.

### Preparation Example 1

Hexamethyldisiloxane (52 g), isopropanol (60 g), and 5 mol/L of hydrochloric acid (120 g) were mixed and stirred at 70° C. for 30 minutes to prepare an IPA solution. Meanwhile, hexadecyltrimethylammonium chloride (2.98g), water (291.4 g), ethylene glycol (50.0 g), and 28% ammonia water (12.1 g) were mixed together, and the resulting aqueous solution was heated to 60° C. Then, tetraethoxysilane (1.62 g) was added thereto and further stirred at 60° C. for 4 hours to prepare a dispersion liquid. After this dispersion liquid was gradually added to the IPA solution, the mixture was stirred at 70° C. for 30 minutes, and subsequently left standing at room temperature for 12 hours. After that, a hexamethyldisiloxane layer containing nanoparticles was collected from the dispersion liquid, and centrifuged (at 4000 rpm, for 90 minutes) to remove the solvent. Thereby, mesoporous silica nanoparticles whose surface was protected with a trimethylsilyl group (surface-hydrophobized mesoporous silica nanoparticles) were obtained.

The average particle diameter of the surface-hydrophobized mesoporous silica nanoparticles was measured by dynamic light scattering using a particle diameter distribution analyzer (“Nanotrac UPA250EX” manufactured by Nikkiso Co., Ltd.). As a result, the average particle diameter was approximately 100 nm.

### Example 1

Ethanol was added to the surface-hydrophobized mesoporous silica nanoparticles obtained in Preparation Example 1 to prepare a dispersion liquid having a nanoparticle concentration of 3.5% by mass. To this dispersion liquid (6 ml), tetraethoxysilane (0.56 g), non-ionic surfactant P123 (manufactured by Sigma-Aldrich Corp., chemical formula: HO (CH2CH20)₂₀(CH2CH(CH3)O) 70 (CH₂CH₂O)₂₀H, 0.14 g), 2 mol/L of hydrochloric acid (80 μl), and water (80 μl) were added, and the mixture was stirred at room temperature for 24 hours. Thus, a mixed sol dispersion liquid was prepared in which a proportion of the nanoparticles in terms of silicon atom was approximately 50% by mass.

A glass substrate was dip coated with the mixed sol dispersion liquid at a speed of 20 mm/minute to form coating films on both surfaces of the glass substrate. The coating films were left standing at room temperature for 24 hours, followed by calcination at 500° C. for 4 hours. Thus, prepared was a glass substrate on both surfaces of which mesoporous silica-mixed thin films made of the mesoporous silica nanoparticles and mesoporous silica matrix material were arranged.

The obtained mesoporous silica-mixed thin films were peeled from the glass substrate, and the nitrogen adsorption isotherm and the pore diameter distribution were determined.

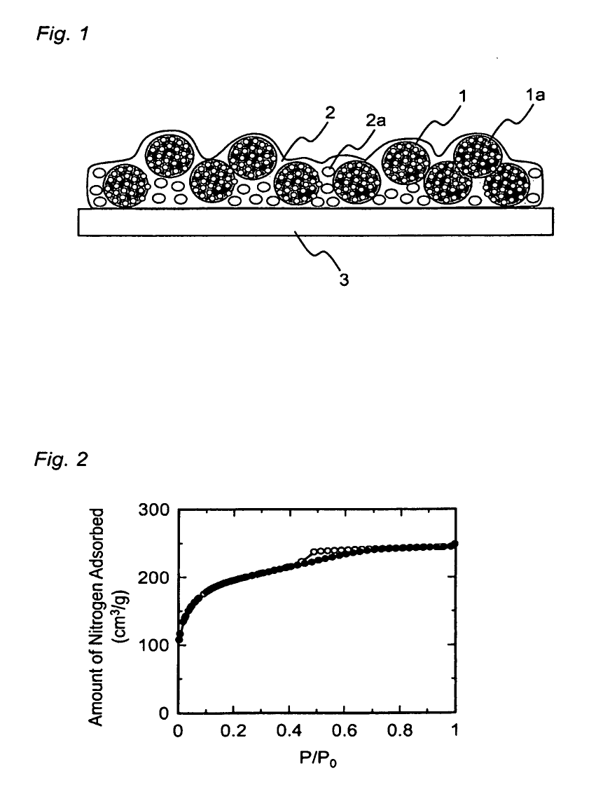

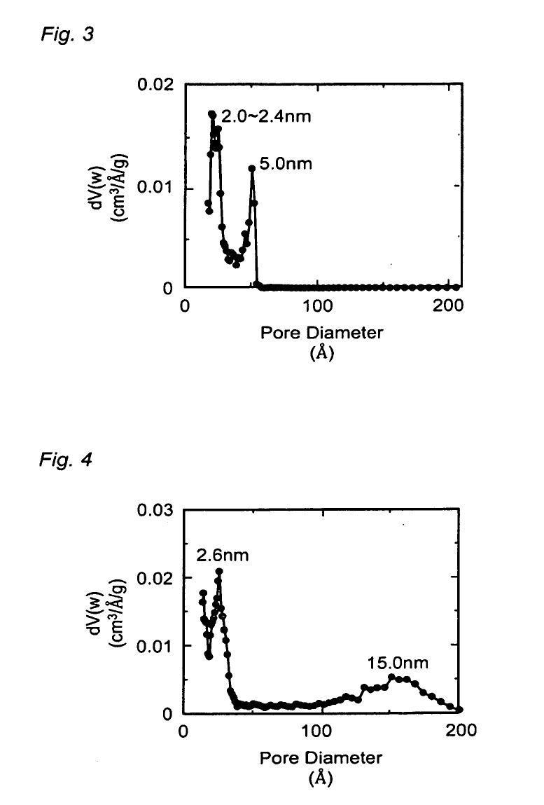

FIG. 2 shows the nitrogen adsorption isotherm, and FIG. 3 shows the pore diameter distribution. It was found from the result shown in FIG. 3 that mesopores having a diameter of 2.0 to 2.4 nm originated from the mesoporous silica nanoparticles and mesopores having a diameter of 5.0 nm originated from the mesoporous silica matrix material were formed independently of each other in the obtained mesoporous silica-mixed thin films. On the other hand, coating films were formed using only the surface-hydrophobized mesoporous silica nanoparticles obtained in Preparation Example 1, and calcined at 500° C. for 4 hours. Then, the pore diameter distribution was determined.

As a result, as shown in FIG. 4, in addition to mesopores having a diameter of 2.6 nm originated from the mesoporous silica nanoparticles, pores having an average diameter of 15 nm originated from voids among the nanoparticles were formed. In contrast, such pores originated from voids among the nanoparticles were not formed in the mesoporous silica-mixed thin films. It was found that in the mesoporous silica-mixed thin film, voids among the nanoparticles were sufficiently filled with the mesoporous silica matrix material. Moreover, the porosity attributable to the mesopores (both of mesopores in the mesoporous silica nanoparticles and mesopores in the mesoporous silica matrix material) in the mesoporous silica-mixed thin film was calculated to be approximately 40%.

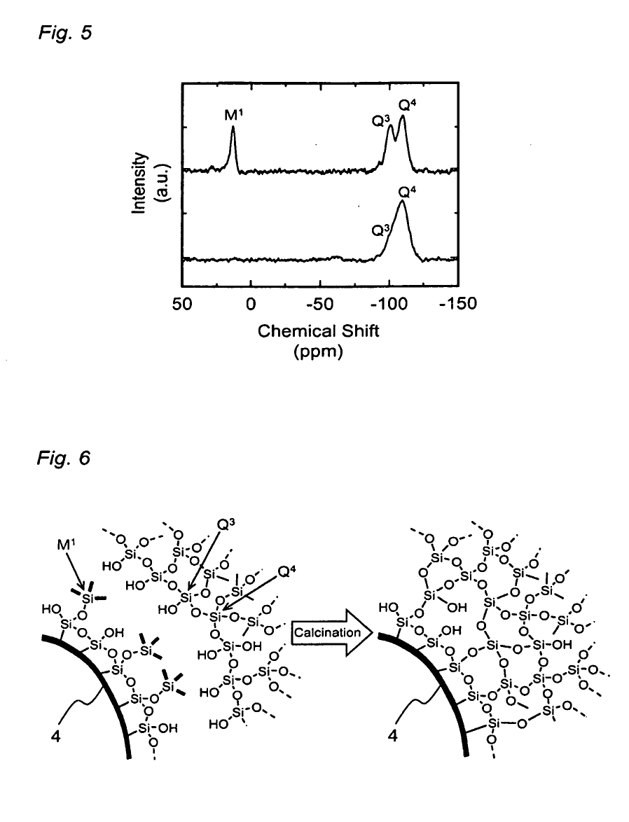

Further, the ²⁹Si solid-state MAS-NMR measurement was performed on the mesoporous silica-mixed thin film. The result of the ²⁹Si solid-state MAS-NMR measurement performed on the mesoporous silica nanoparticles before the calcination is shown at the top of FIG. 5, while the result of the ²⁹Si solid-state MAS-NMR measurement performed on the mesoporous silica-mixed thin film is shown at the bottom of FIG. 5. These results revealed that, as shown in FIG. 6, the trimethylsilyl group (M¹:Si—O—SiMe₃) introduced to the mesoporous silica nanoparticle surface 4 was decomposed by the calcination, and Si atoms on the nanoparticle surface 4 formed covalent bonds (Q³: HOSi(OSi)₃, Q⁴: Si(OSi)₄) with Si atoms of the mesoporous silica matrix material via oxygen atoms.

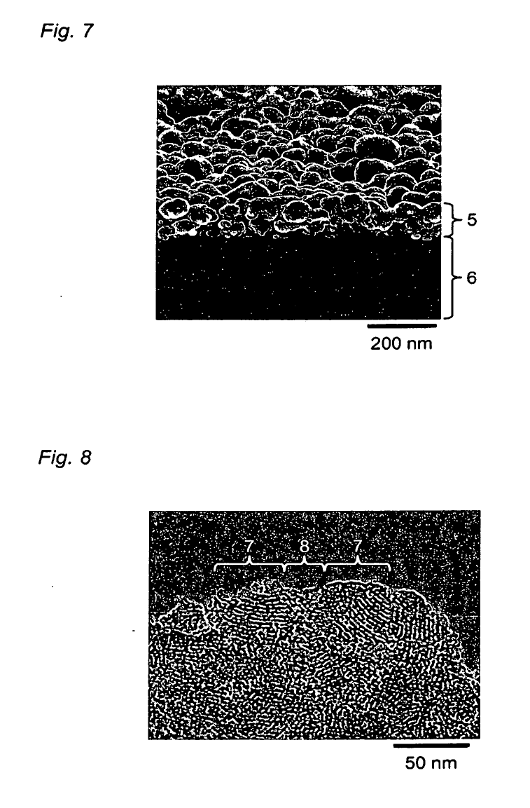

Furthermore, the mesoporous silica-mixed thin film was observed with the scanning electron microscope (SEM) and the transmission electron microscope (TEM). It was found from the SEM photograph shown in FIG. 7 that binding of the mesoporous silica nanoparticles formed a mixed thin film 5 on a glass substrate 6, and exposure of the nanoparticles formed a concavity and convexity structure on a surface of the mixed thin film 5, the concavity and convexity structure having projections with pitches of 70 to 180 nm (average pitch: 95 nm) and heights of 30 to 100 nm (average height: 50 nm) . In addition, the TEM photograph shown in FIG. 8 verified that the mesoporous structure was formed not only in a silica nanoparticle region 7 but also in a silica matrix material region 8.

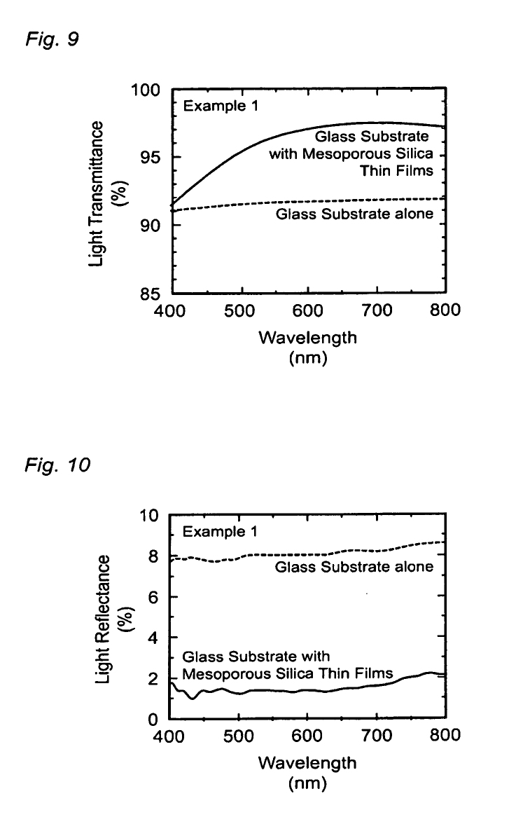

Moreover, the thickness and the refractive index of the mesoporous silica-mixed thin film were measured. The average film thickness was 80 nm, and the average refractive index was 1.32. Further, the light transmittance and the light reflectance of the glass substrate on the surfaces of which the mesoporous silica-mixed thin films were arranged were measured at each wavelength. FIG. 9 shows a wavelength dependence of the light transmittance, and FIG. 10 shows a wavelength dependence of the light reflectance . In addition, Table 1 shows the light transmittance and the light reflectance at wavelengths of 450 nm, 600 nm, and 750 nm. From the result shown in FIG. 9, the light transmittance of the glass substrate on the surfaces of which the mesoporous silica-mixed thin films were arranged was higher than the light transmittance of the glass substrate alone in the entire visible light region. It was found that forming the mesoporous silica-mixed thin film on the surface of the glass substrate improved the light transmittance. Further, as shown in FIG. 10, the light reflectance of the glass substrate on the both surfaces of which the mesoporous silica-mixed thin films were arranged was 1.2 to 2.2% (0.6 to 1.1% for each surface) and low in comparison with the case of the glass substrate alone (approximately 8%), revealing that it was possible to greatly decrease the light reflectance by forming the mesoporous silica-mixed thin film on the surface of the glass substrate. In other words, it was found that the mesoporous silica-mixed thin film was excellent in antireflection properties.

In addition, the abrasion resistance test was conducted on the mesoporous silica-mixed thin film. As a result, as shown in Table 1, neither peeling nor scar on the surface of the mesoporous silica-mixed thin film was observed after the test. It was found that the mesoporous silica-mixed thin film had a sufficient mechanical strength.

### Example 2

The glass substrate on the both surfaces of which the mesoporous silica-mixed thin films were arranged, which was prepared in Example 1, was immersed in a toluene solution containing 5% by mass of trimethylchlorosilane, and heated at 60° C. for 1 hour to thereby subject the thin film surfaces to a hydrophobizing treatment. Then, the thin films were washed with hexane and methanol, and dried by heating at 80° C. for 2 hours.

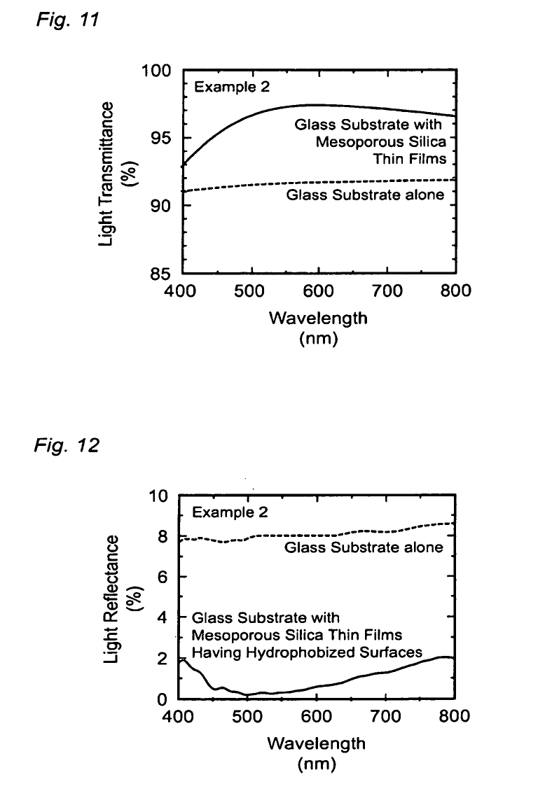

The average refractive index of the mesoporous silica-mixed thin film having the film surface subjected to the hydrophobizing treatment was measured to be 1.35. Moreover, the light transmittance and the light reflectance of the glass substrate on the surfaces of which the mesoporous silica-mixed thin films each having the film surface subjected to the hydrophobizing treatment were arranged were measured at each wavelength. FIG. 11 shows a wavelength dependence of the light transmittance, and FIG. 12 shows a wavelength dependence of the light reflectance. In addition, Table 1 shows the light transmittance and the light reflectance at wavelengths of 450 nm, 600 nm, and 750 nm. A comparison between the result shown in FIG. 9 and the result shown in FIG. 11 indicates that subjecting the film surface to the hydrophobizing treatment increased the light transmittance in a short wavelength region (particularly, a wavelength region of 400 to 600 nm) . Further, a comparison between the result shown in FIG. 10 and the result shown in FIG. 12 indicates that subjecting the film surface to the hydrophobizing treatment decreased the light reflectance in a short wavelength region (particularly, a wavelength region of 400 to 600 nm). In other words, it was found that it was possible to improve the light transmittance and the antireflection properties at the short wavelength by subjecting the film surface to the hydrophobizing treatment.

In addition, the abrasion resistance test was conducted on the mesoporous silica-mixed thin film having the film surface subjected to the hydrophobizing treatment. As a result, as shown in Table 1, neither peeling nor scar on the surface of the mesoporous silica-mixed thin film having the film surface subjected to the hydrophobizing treatment was observed after the test. It was found that the mesoporous silica-mixed thin film had a sufficient mechanical strength.

### Example 3

The glass substrate on the both surfaces of which the mesoporous silica-mixed thin films were arranged, which was prepared in Example 1, was immersed in a toluene solution containing 5% by mass of 3,3,3-trifluoropropyldimethylchlorosilane, and heated at 60° C. for 1 hour to thereby subject the thin film surfaces to a hydrophobizing treatment. Then, the thin films were washed with hexane and methanol, and dried by heating at 80° C. for 2 hours.

The average refractive index of the mesoporous silica-mixed thin film having the film surface subjected to the hydrophobizing treatment was measured to be 1.35. Moreover, the light transmittance and the light reflectance of the glass substrate on the surfaces of which the mesoporous silica-mixed thin films each having the film surface subjected to the hydrophobizing treatment were arranged were measured at each wavelength. As a result, it was found as shown in Table 1 that it was possible to decrease the light reflectance to 1.2% or less while keeping the light transmittance as high as 90% or more, by subjecting the film surface to the hydrophobizing treatment using 3,3,3-trifluoropropyldimethylchlorosilane.

In addition, the abrasion resistance test was conducted on the mesoporous silica-mixed thin film having the film surface subjected to the hydrophobizing treatment. As a result, as shown in Table 1, neither peeling nor scar on the surface of the mesoporous silica-mixed thin film having the film surface subjected to the hydrophobizing treatment using 3,3,3-trifluoropropyldimethylchlorosilane was observed after the test. It was found that the mesoporous silica-mixed thin film had a sufficient mechanical strength.

### Example 4

Ethanol was added to the surface-hydrophobized mesoporous silica nanoparticles obtained in Preparation Example 1 to prepare a dispersion liquid having a nanoparticle concentration of 5% by mass. To this dispersion liquid (6 ml), tetraethoxysilane (0.48 g), non-ionic surfactant P123 (0.12 g), 2 mol/L of hydrochloric acid (80 μl), and water (80 μl) were added, and the mixture was stirred at room temperature for 24 hours. Thus, a mixed sol dispersion liquid was prepared in which a proportion of the nanoparticles in terms of silicon atom was approximately 65% by mass.

A glass substrate on both surfaces of which mesoporous silica-mixed thin films made of mesoporous silica nanoparticles and a mesoporous silica matrix material were arranged was prepared in the same manner as in Example 1, except that the above-described mixed sol dispersion liquid was used. The obtained mesoporous silica-mixed thin films were peeled from the glass substrate, and the nitrogen adsorption isotherm and the pore diameter distribution were determined. The porosity attributable to mesopores (both of mesopores in the mesoporous silica nanoparticles and mesopores in the mesoporous silica matrix material) was calculated to be approximately 30%.

Moreover, the mesoporous silica-mixed thin film was observed with the scanning electron microscope (SEM) to measure pitches and heights of projections in a concavity and convexity structure on the surface. As a result, the pitches were 70 to 180 nm (average pitch: 90 nm) and the heights were 30 to 150 nm (average height: 60 nm).

Further, the thickness and the refractive index of the mesoporous silica-mixed thin film were measured. The average film thickness was 100 nm, and the average refractive index was 1.26. Furthermore, the light transmittance and the light reflectance of the glass substrate on the surfaces of which the mesoporous silica-mixed thin films were arranged were measured at each wavelength. As a result, it was verified as shown in Table 1 that the mesoporous silica-mixed thin film formed were excellent in light transmittance and antireflection properties.

In addition, the abrasion resistance test was conducted on the mesoporous silica-mixed thin film. As a result, as shown in Table 1, neither peeling nor scar on the surface of the mesoporous silica-mixed thin film was observed after the test. It was found that the mesoporous silica-mixed thin film had a sufficient mechanical strength.

### Example 5

To an ethanol solution (4.5 g) containing 11% by mass of polydimethoxysiloxane (“PSI-026” manufactured by Gelest, Inc.), 2 mol/L of hydrochloric acid (0.1 g) was added to prepare a sol solution. A glass substrate was dip coated with the sol solution at a speed of 20 mm/minute to form coating films on both surfaces of the glass substrate. The coating films were calcined at 500° C. for 4 hours. Thus, prepared was a glass substrate on both surfaces of which silica coating films each. having a thickness of approximately 100 nm were arranged.

A mesoporous silica-mixed thin film made of mesoporous silica nanoparticles and a mesoporous silica matrix material was formed on each of surfaces of the silica coating films in the same manner as in Example 1, except that the glass substrate on the both surfaces of which the silica coating films were arranged was used in place of the glass substrate in Example 1. Thus, prepared was a glass substrate on both surfaces of which multilayer thin films of the mesoporous silica-mixed thin film and the silica coating film were arranged.

The light transmittance and the light reflectance of the obtained glass substrate on the surfaces of which the multilayer thin films were arranged were measured at each wavelength. As a result, as shown in Table 1, the light transmittance at a long wavelength (750 nm) was increased and the light reflectance was decreased in comparison with the case of the mesoporous silica-mixed thin film monolayer. In other words, it was found that it was possible to improve the light transmittance at the long wavelength and the antireflection properties by forming the multilayer thin film of the mesoporous silica-mixed thin film and the silica coating film.

In addition, the abrasion resistance test was conducted on the multilayer thin film. As a result, as shown in Table 1, neither peeling nor scar on the surface of the multilayer thin film was observed after the test. It was found that the multilayer thin film had a sufficient mechanical strength.

### Comparative Example 1

Tetraethoxysilane (2.0 g), non-ionic surfactant P123 (0.50 g), ethanol (15 ml), 2 mol/L of hydrochloric acid (0.2 ml), and water (0.2 ml) were mixed and stirred at room temperature for 24 hours to prepare a sol solution. A glass substrate was dip coated with the sol solution at a speed of 20 mm/minute to form coating films on both surfaces of the glass substrate. The coating films were left standing at room temperature for 24 hours and then calcined at 500° C. for 4 hours.

Thus, prepared was a glass substrate on both surfaces of which mesoporous silica thin films made of the mesoporous silica matrix material were arranged.

The obtained mesoporous silica thin films were peeled from the glass substrate, and the nitrogen adsorption isotherm and the pore diameter distribution were determined. The porosity attributable to mesopores was calculated to be approximately 40%. Moreover, the mesoporous silica thin film was observed with the scanning electron microscope (SEM), but no concavity and convexity structure was observed on the surface.

Further, the thickness and the refractive index of the mesoporous silica thin film were measured. The average film thickness was 70 nm, and the average refractive index was 1.35. Furthermore, the light transmittance and the light reflectance of the glass substrate on the surfaces of which the mesoporous silica thin films were arranged were measured at each wavelength. As a result, as shown in Table 1, the mesoporous silica thin film was excellent in light transmittance, but had a light reflectance of 1.9% or more at a wavelength of 600 nm or more. The antireflection properties were poor for light in a long wavelength region.

In addition, the abrasion resistance test was conducted on the mesoporous silica thin film. As a result, as shown in Table 1, neither peeling nor scar on the surface of the mesoporous silica thin film was observed after the test. The mesoporous silica thin film had a sufficient mechanical strength.

### Comparative Example 2

Ethanol was added to the surface-hydrophobized mesoporous silica nanoparticles obtained in Preparation Example 1 to prepare a dispersion liquid having a nanoparticle concentration of 2.0% by mass. To this dispersion liquid (3.0 g), polydimethoxysiloxane (“PSI-026” manufactured by Gelest, Inc., 15 mg), and an ethanol solution (0.5 g) containing hydrochloric acid (5 μl) were added. Thus, a mixed sol dispersion liquid was prepared in which a mass ratio between the surface-hydrophobized mesoporous silica nanoparticles and polydimethoxysiloxane was 80/20.

Both surfaces of a glass substrate were spin coated (at 3000 rpm, for 30 seconds) with the mixed sol dispersion liquid to form coating films on the both surfaces of the glass substrate.

The coating films were dried by heating at 85° C. for 1 hour. Thus, prepared was a glass substrate on both surfaces of which mesoporous silica thin films made of the mesoporous silica nanoparticles and non-porous silica matrix material (in the thin film, the mesoporous silica nanoparticles were partially immobilized) were arranged.

The obtained mesoporous silica thin films were peeled from the glass substrate, and the nitrogen adsorption isotherm and the pore diameter distribution were determined. The porosity attributable to mesopores was calculated to be approximately 50%. Moreover, the mesoporous silica thin film was observed with the scanning electron microscope (SEM) to measure pitches and heights of projections in a concavity and convexity structure on the surface. As a result, the pitches were 50 to 180 nm (average pitch: 100 nm) and the heights were 30 to 180 nm (average height: 90 nm).

Further, the thickness and the refractive index of the mesoporous silica thin film were measured. The average film thickness was 140 nm, and the average refractive index was 1.17. Furthermore, the light transmittance and the light reflectance of the glass substrate on the surfaces of which the mesoporous silica thin films were arranged were measured at each wavelength. As a result, as shown in Table 1, the mesoporous silica thin film was excellent in light transmittance and antireflection properties.

On the other hand, the abrasion resistance test was conducted on the mesoporous silica thin film. As a result, as shown in Table 1, the mesoporous silica thin film was completely peeled after the test. The abrasion resistance was poor.

### Comparative Example 3

In the same manner as in Comparative Example 2, prepared was a glass substrate on both surfaces of which mesoporous silica thin films made of the mesoporous silica nanoparticles and non-porous silica matrix material (in the thin film, the mesoporous silica nanoparticles were partially immobilized) were arranged. The mesoporous silica thin films were further calcined at 500° C. for 4 hours.

The obtained mesoporous silica thin films were peeled from the glass substrate, and the nitrogen adsorption isotherm and the pore diameter distribution were determined. The porosity attributable to mesopores was calculated to be approximately 30%. Moreover, the mesoporous silica thin film was observed with the scanning electron microscope (SEM) to measure pitches and heights of projections in a concavity and convexity structure on the surface. As a result, the pitches were 30 to 150 nm (average pitch: 80 nm) and the heights were 30 to 90 nm (average height: 60 nm).

Further, the thickness and the refractive index of the mesoporous silica thin film were measured. The average film thickness was 63 nm, and the average refractive index was 1.37. Furthermore, the light transmittance and the light reflectance of the glass substrate on the surfaces of which the mesoporous silica thin films were arranged were measured at each wavelength. As a result, as shown in Table 1, the mesoporous silica thin film was excellent in light transmittance, but had a light reflectance of 1.8% or more at a wavelength of 450 nm or more. The antireflection properties were decreased by the calcination.

In addition, the abrasion resistance test was conducted on the mesoporous silica thin film. As a result, as shown in Table 1, the mesoporous silica thin film was completely peeled after the test. The abrasion resistance was not improved.

### Comparative Example 4

A glass substrate on both surfaces of which mesoporous silica thin films made of mesoporous silica nanoparticles and a non-porous silica matrix material were arranged was prepared in the same manner as in Comparative Example 2, except that the mass ratio between the surface-hydrophobized mesoporous silica nanoparticles and polydimethoxysiloxane was altered to 50/50.

The obtained mesoporous silica thin films were peeled from the glass substrate, and the nitrogen adsorption isotherm and the pore diameter distribution were determined. The porosity attributable to mesopores was calculated to be approximately 30%. Moreover, the mesoporous silica thin film was observed with the scanning electron microscope (SEM) to measure pitches and heights of projections in a concavity and convexity structure on the surface. As a result, the pitches were 30 to 150 nm (average pitch: 80 nm) and the heights were 60 to 120 nm (average height: 80 nm).

Further, the thickness and the refractive index of the mesoporous silica thin film were measured. The average film thickness was 100 nm, and the average refractive index was 1.18. Furthermore, the light transmittance and the light reflectance of the glass substrate on the surfaces of which the mesoporous silica thin films were arranged were measured at each wavelength. As a result, as shown in Table 1, the mesoporous silica thin film was excellent in light transmittance and antireflection properties, but was not improved as much as the mesoporous silica thin film obtained in Comparative Example 2.

In addition, the abrasion resistance test was conducted on the mesoporous silica thin film. As a result, as shown in Table 1, the mesoporous silica thin film was completely peeled after the test. The abrasion resistance was not improved.

### Comparative Example 5

A glass substrate on both surfaces of which mesoporous silica thin films made of mesoporous silica nanoparticles and a non-porous silica matrix material were arranged was prepared in the same manner as in Comparative Example 2, except that the mass ratio between the surface-hydrophobized mesoporous silica nanoparticles and polydimethoxysiloxane was altered to 30/70.

The obtained mesoporous silica thin films were peeled from the glass substrate, and the nitrogen adsorption isotherm and the pore diameter distribution were determined. The porosity attributable to mesopores was calculated to be approximately 20%. Moreover, the mesoporous silica thin film was observed with the scanning electron microscope (SEM) to measure pitches and heights of projections in a concavity and convexity structure on the surface. As a result, the pitches were 30 to 150 nm (average pitch: 80 nm) and the heights were 40 to 100 nm (average height: 60 nm).

Further, the thickness of the mesoporous silica thin film was measured, and the average film thickness was approximately 100 nm. It was impossible to measure the refractive index due to an influence of the light scattering. Furthermore, the light transmittance and the light reflectance of the glass substrate on the surfaces of which the mesoporous silica thin films were arranged were measured at each wavelength. As a result, as shown in Table 1, the mesoporous silica thin film was excellent in light transmittance, but had a light reflectance of 3.0% or more at a wavelength of 450 nm or more. The antireflection properties were decreased in comparison with the mesoporous silica thin film obtained in Comparative Example 2.

In addition, the abrasion resistance test was conducted on the mesoporous silica thin film. As a result, as shown in Table 1, no peeling of the mesoporous silica thin film was observed after the test, but a scar was observed on some area of the surface. The abrasion resistance was not sufficiently improved.

### Comparative Example 6

In the same manner as in Comparative Example 5, prepared was a glass substrate on both surfaces of which mesoporous silica thin films made of the mesoporous silica nanoparticles and a non-porous silica matrix material were arranged. The mesoporous silica thin films were further calcined at 500° C. for 4 hours.

The obtained mesoporous silica thin films were peeled from the glass substrate, and the nitrogen adsorption isotherm and the pore diameter distribution were determined. The porosity attributable to mesopores was calculated to be approximately 15%. Moreover, the mesoporous silica thin film was observed with the scanning electron microscope (SEM) to measure pitches and heights of projections in a concavity and convexity structure on the surface. As a result, the pitches were 30 to 120 nm (average pitch: 60 nm) and the heights were 20 to 80 nm (average height: 40 nm). Further, the thickness of the mesoporous silica thin film was measured, and the average film thickness was approximately 70 nm. It was impossible to measure the refractive index due to an influence of the light scattering. Furthermore, the light transmittance and the light reflectance of the glass substrate on the surfaces of which the mesoporous silica thin films were arranged were measured at each wavelength. As a result, as shown in Table 1, the mesoporous silica thin film was excellent in light transmittance, but had a light reflectance of 3.2% or more at a wavelength of 450 nm or more. The antireflection properties were further decreased in comparison with the mesoporous silica thin film obtained in Comparative Example 5.

On the other hand, the abrasion resistance test was conducted on the mesoporous silica thin film. As a result, as shown in Table 1, neither peeling nor scar on the surface of the mesoporous silica thin film was observed after the test.

The abrasion resistance was improved by the calcination.

### Comparative Example 7

A mixed sol dispersion liquid in which a proportion of nanoparticles in terms of silicon atom was approximately 50% by mass was prepared in the same manner as in Example 1, except that mesoporous silica nanoparticles (manufactured by Sigma-Aldrich Corp., product number: 748161) having non-hydrophobized surface were used in place of the surface-hydrophobized mesoporous silica nanoparticles.

A glass substrate was dip coated with the mixed sol dispersion liquid at a speed of 20 mm/minute to form coating films on both surfaces of the glass substrate. The coating films were dried while being left standing at room temperature for 24 hours. The dried coating films were washed with ethanol, followed by vacuum drying. Thus, prepared was a glass substrate on both surfaces of which silica-mixed thin films made of the silica nanoparticles and silica matrix material were arranged.

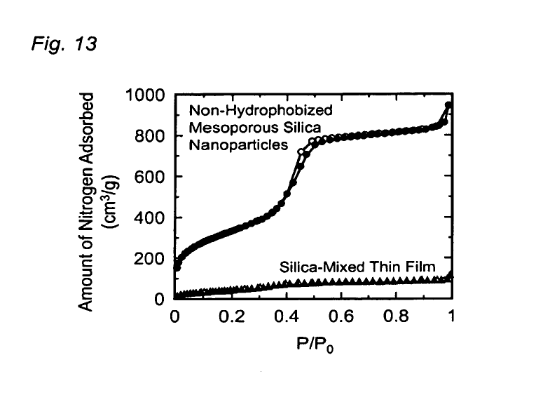

The obtained silica-mixed thin films were peeled from the glass substrate, and the nitrogen adsorption isotherm was determined. FIG. 13 shows the result. Moreover, FIG. 13 also shows a nitrogen adsorption isotherm of the mesoporous silica nanoparticles having non-hydrophobized surface used as the raw material. As apparent from the result shown in FIG. 13, it was found that, in the silica-mixed thin film formed using the sol dispersion liquid containing the mesoporous silica nanoparticles having non-hydrophobized surface, the alkoxysilane, and the surfactant, the amount of nitrogen adsorbed was greatly reduced, and most of the mesopores were filled. Further, the porosity attributable to the mesopores of the silica-mixed thin film was calculated to be approximately 18%, and hence greatly decreased in comparison with the porosity attributable to mesopores of the mesoporous silica nanoparticles having non-hydrophobized surface used as the raw material (approximately 69%) and the porosity attributable to mesopores of the mesoporous silica-mixed thin film obtained in Example 1 (approximately 40%).

TABLE 1

| | Light transmittance (%) | | | Light reflectance (%) | | | Wear |
|---|---|---|---|---|---|---|---|
| | 450 nm | 600 nm | 750 nm | 450 nm | 600 nm | 750 nm | resistance |
| Example 1 | 93.5 | 97 | 97.4 | 1.4 | 1.4 | 2 | neither peeling |
| | | | | | | | nor scar |
| Example 2 | 95.2 | 97.4 | 96.9 | 0.5 | 0.6 | 1.8 | neither peeling |
| | | | | | | | nor scar |
| Example 3 | 91.8 | 96 | 97.8 | 0.7 | 0.9 | 1.2 | neither peeling |
| | | | | | | | nor scar |
| Example 4 | 84.1 | 93.2 | 96.2 | 1.1 | 0.3 | 0.7 | neither peeling |
| | | | | | | | nor scar |
| Example 5 | 92.4 | 96.2 | 98.1 | 0.5 | 0.9 | 0.5 | neither peeling |
| | | | | | | | nor scar |
| Comparative | 98.2 | 97.8 | 96.5 | 1.2 | 1.9 | 3.3 | neither peeling |
| Example 1 | | | | | | | nor scar |
| Comparative | 89.6 | 95.2 | 97.2 | 1.2 | 0.9 | 0.9 | completely |
| Example 2 | | | | | | | peeled |
| Comparative | 94 | 96.2 | 95.8 | 2.2 | 1.8 | 3 | completely |
| Example 3 | | | | | | | peeled |
| Comparative | 89.9 | 94.4 | 94.9 | 1.2 | 1.5 | 2.1 | completely |
| Example 4 | | | | | | | peeled |
| Comparative | 90.3 | 92.5 | 93.6 | 3 | 4.9 | 4.8 | partial |
| Example 5 | | | | | | | scar |
| Comparative | 91 | 93 | 93.4 | 3.2 | 5.1 | 5.3 | neither peeling |
| Example 6 | | | | | | | nor scar |

As described above, according to the present invention, an antireflection film having both antireflection properties and abrasion resistance can be easily obtained.

Therefore, the antireflection film of the present invention is excellent not only in antireflection properties and abrasion resistance, but also excellent in light transmittance in the visible light region. Accordingly, the antireflection film of the present invention is useful as an antireflection film used for members required to have a high transparency, such as display devices such as displays and windshields of automobiles.

### REFERENCE SIGNS LIST

1: mesoporous nanoparticles, 1a: mesopores, 2: mesoporous transparent material, 2a: mesopores, 3: substrate, 4: surface of mesoporous silica nanoparticles, 5: mesoporous silica-mixed thin film, 6: glass substrate, 7: region of silica nanoparticles, 8: region of silica matrix material.

What is claimed is:

1. An antireflection film comprising:
mesoporous nanoparticles having a metal oxide framework and an average particle diameter of 30 to 200 nm; and
a mesoporous transparent material having a metal oxide framework and filling voids among the nanoparticles.

2. The antireflection film according to claim 1, wherein the mesoporous nanoparticles have a silica framework.

3. The antireflection film according to claim 1, wherein the mesoporous transparent material has a silica framework.

4. The antireflection film according to claim 1, which has a concavity and convexity structure on a surface thereof with projections having an average pitch of 30 to 200 nm and an average height of 20 to 150 nm.

5. The antireflection film according to claim 1, wherein a porosity attributable to mesopores which is determined from a nitrogen adsorption isotherm is 20 to 65%.

6. The antireflection film according to claim 1, wherein an average refractive index measured by spectroscopic ellipsometry is 1.20 to 1.44.

7. The antireflection film according to claim 1, wherein a content of the mesoporous nanoparticles in terms of metal atom is 20 to 80% by mass.

8. The antireflection film according to claim 1, which has a surface subjected to a hydrophobizing treatment.

9. A multilayer antireflection film comprising:
a transparent film having a metal oxide framework; and
the antireflection film according to claim 1 arranged on a surface of the transparent film.

10. The multilayer antireflection film according to claim 9, wherein the transparent film has a silica framework.

11. A method for producing an antireflection film, comprising:
preparing a sol dispersion liquid containing mesoporous nanoparticles having a metal oxide framework, a hydrophobized surface and an average particle diameter of 30 to 200 nm, a metal alkoxide, and a surfactant;
forming a coating film using the sol dispersion liquid; and
calcining the obtained coating film to form a film containing the mesoporous nanoparticles and a mesoporous transparent material.

12. The method for producing an antireflection film according to claim 11, comprising subjecting a surface of the film obtained after the calcination to a hydrophobizing treatment.

13. A method for producing a multilayer antireflection film, comprising forming a film containing the mesoporous nanoparticles and the mesoporous transparent material on a surface of a transparent film having a metal oxide framework by the production method according to claim 11.
